(19) United States
(12) Patent Application Publication
(10) Pub. No.: US 2008/0274715 A1
(43) Pub. Date: Nov. 6, 2008

(54) Call Cost Indicator For Mobile Devices

(76) Inventors: David Lloyd Heit, Waterloo (CA); Atul Asthana, Unionville (CA); Douglas Michael Gisby, Atlanta, GA (US); Ian James McDonald, Waterloo (CA); Brian Oliver, Fergus Falls (CA); John-Luc Bakker, Flemington, NJ (US); Nicholas Alfano, Stratford-Upon-Avon (GB)

Correspondence Address: ECKERT SEAMANS CHERIN & MELLOTT, 600 GRANT STREET, 44TH FLOOR, PITTSBURGH, PA, 15219, US

(21) Appl. No.: 11/742,953

(22) Filed: May 1, 2007

(51) Int. Cl. H04M 11/00

(52) U.S. Cl. 455/406

(57) ABSTRACT

A method and apparatus to enhance decision making capabilities of a user of a mobile device, the method having the steps of: receiving, at the mobile device, information related to the cost of mobile services; and communicating an indication of the cost of mobile services to the user.

### FIELD OF THE DISCLOSURE

The present disclosure relates to mobile devices, and in particular, to the provision of information to users of mobile devices.

### BACKGROUND

Users of mobile devices or mobile user equipment (UE) are increasingly becoming more sophisticated in terms of functionality that they require from their mobile devices. Further, enterprises are increasingly utilizing management and information technology policies for mobile devices within the enterprise.

One piece of information that would be useful on mobile devices is the cost of a transaction. A transaction could include circuit switched services such as a voice call or short message service/multimedia message service (SMS/MMS). Alternatively, a transaction could be a packet switched service such as the downloading of information from a website. This information would be helpful to a user or enterprise when controlling charges for the mobile device.

With the introduction of multi-mode handheld devices, the user may also wish to know the cost of a call over a specific network service. For example, the cost of transferring data over a WiFi service may be less than the transferring over the mobile network.

### BRIEF DESCRIPTION OF THE DRAWINGS

The present disclosure will be better understood with reference to the drawings in which:

FIG. 1 is diagram showing an exemplary mobile device with multiple cost indications provided;

FIG. 2 is data flow diagram of one embodiment of a system for providing cost indicators;

FIG. 3 is a data flow diagram of a further embodiment of a system for providing cost indicators;

FIG. 4 is a simplified block diagram of a telephony server; and

FIG. 5 is a block diagram of an exemplary mobile device.

### DETAILED DESCRIPTION

The present disclosure provides a handheld user with a display or indication, either visual or audio, of the cost of mobile services. Such mobile services include, but are not limited to, voice calls and/or the cost of data transfer at a given instance in time based on the location, network service, subscription (billing plan) or other factors of the mobile device. As used herein, a call cost indicator is an indicator of the cost of both packet switched and circuit switched services. Such information provides a user with the ability to make informed decisions regarding the use of the mobile device.

The call cost indicator could provide information such as a cost per minute for voice call to a long distance destination, cost per minute for local calls, applied roaming charges, the number of minutes consumed and minutes available in the user's calling plans over a specific time period per month, the number of bytes transmitted or received over a period or a current consumption of data transfers and the maximum allowed before additional costs are applied and the costs for telephony or data services at different times of the day.

In one embodiment, the call cost indicator may be an icon on a handheld screen or a dashboard style display or other type of graphical or audio representation showing the cost of a call or data transfer or other information pertaining to the user's intended action.

In a further embodiment, other information, such as the quality of a voice call may be included in the information provided. Such quality indication could use terms such as low, medium or high to provide some other type of scaling to show voice quality.

A telephony server can be used to collect information about a user's billing plan and information regarding the user telephone service usage. As used herein, a telephony server can be a server for circuit switched or packet switched transactions and can collect information about either data or voice calls. The information can be stored in a telephony server database and when a user enters a voice call or clicks on a URL, the handheld can pass a query to the telephony server asking for cost estimates for these activities. Alternatively, a client on the handheld can be passively interacting with the mobile service to be updated with the latest costing information based on location, subscription and network service the handheld is currently using.

The present disclosure therefore provides a method to enhance decision making capabilities of a user of a mobile device comprising the steps of: receiving, at the mobile device, information related to the cost of mobile services; and communicating an indication of the cost of mobile services to the user.

The present disclosure further provides a mobile device adapted to enhance decision making capabilities of a user comprising: a receiver adapted to receive information related to the cost of mobile service; and an output adapted to provide an indication of the cost of mobile services to the user.

The present disclosure further provides a telephony server comprising: a communications subsystem; a processor adapted to query, through said communications subsystem, other servers regarding costs of mobile services; and memory for storing results of the queries by the processor related to information for the costs of mobile services, wherein said communications subsystem is further adapted to communicate the information for the costs of mobile services to one or more mobile devices.

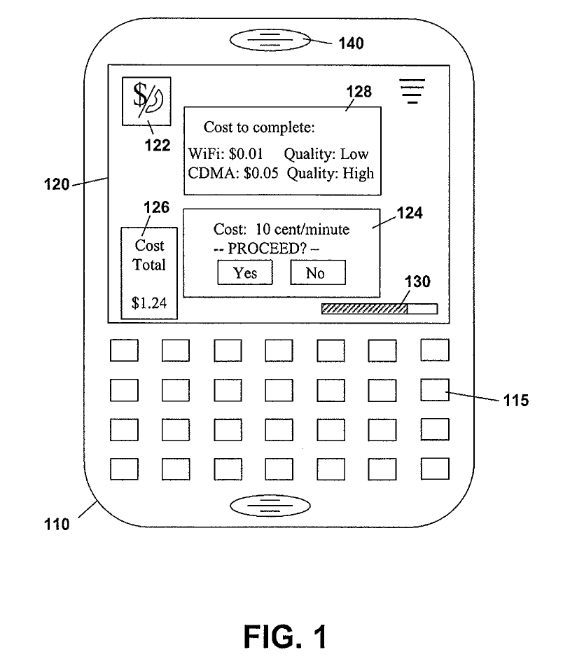

Reference is now made to FIG. 1. FIG. 1 shows an exemplary mobile device 110 having a keyboard or other input 115, a display 120 and a speaker 140.

Input 115 could comprise a keyboard, keypad, scroll wheel, touch pad, or other input means that would be known to those skilled in the art.

The present disclosure relates to the providing of a cost indicator on mobile device 110. As such, an indicator could be provided on display 120. The diagram of FIG. 1 shows various examples of indicators on a display that could be used, but is not meant to be limited to these indicators, as described below.

In order to provide a user with enhanced decision making ability regarding whether to proceed with a transaction, a cost indicator is provided. A cost indicator for user will vary depending on the action being performed by the user, the capabilities of the mobile device and the level of detail required by the user or enterprise.

Referring to the exemplary device of FIG. 1, a first call indicator is passive icon 122. In the embodiment of FIG. 1, the passive icon 122 on display 120 can be clicked at any time to display the current costs of calls to various destinations or allow a user to enter a number and request a cost estimate. The icon 122 could further be used to show the cost of ongoing voice calls or data transfers.

Clicking icon 122 provides information such as a cost per minute for a voice call to a long distance destination. This could, for example, be provided immediately preceding a voice call to indicate that the intended call will cost a certain amount per minute, such as in popup screen 124. Alternatively, the information could be provided in a table form (not shown) to the user to indicate the costs for various regions from the current location of the mobile device. For example, a user intending to make a voice call could click on icon 122 to open a table to provide information about the cost for calling long distance to whatever countries are specified in the table.

Display 120 could show a popup screen 124 that could be displayed immediately after a number is dialed or a URL is clicked to download a large file, but prior to the actual execution of the call or download, showing the cost of the intended action. The popup screen 124 in one embodiment displays the estimated cost of the call or a data transfer and asks a user if they wish to proceed.

As will be appreciated by those skilled in the art, the popup screen 124 could display either the cost for a specific time period or an absolute cost. For example, for a voice call it may be more appropriate to display that the call would cost 10 cents per minute. For a download of a large file, the file size may be known in advance and therefore the popup screen 124 could display an absolute cost such as 25 cents to download a specific file.

Other call cost indicators could include a cost-per-minute for local calls. The cost could be broken down into the cost for the long distance services and for any roaming charges.

Display 120 could further show a window 126 that could show the cost of a call during the call and provide the total at the end of the call. Such a window is, for example, a dashboard. Alternatively, a popup window could appear at the end of a call showing the total costs for the call.

Other indicators on display 120 could also be shown. For example, a bar 130 could indicate the number of minutes a user has consumed in a monthly billing plan and the number of minutes available. The bar could indicate this in a graphical format but could be clicked to indicate a precise amount. Alternatively, windows could show the exact amount or the amount could be retrieved by clicking a passive icon.

Thus the cost could be indicative of the number of minutes consumed and the number of minutes available on the user's calling plan over a specific time period. If, for example, a user has 300 minutes of long distance time per month, the cost indicator could indicate that the user has consumed 157 minutes and thus has 143 minutes remaining. Similarly, the number of bytes transmitted and received over a period, such as a month, could be provided and the current consumption of data transfers and the maximum allowed before additional costs are applied could be shown.

On multi-mode devices with two or more communications channels, other options are available. A window 128 on display 120 could be opened prior to a call being made when two or more network services are available for the mobile device 110. For example, a user may wish to see a comparison for a voice call where the voice call is directed over a WiFi network service or over a mobile service. Window 128 may include quality estimates as well. For example, in the display window 128 of FIG. 1, the window shows that a call over WiFi may be 1 cent per minute but the voice quality may be low, whereas the call over a wireless network such as CDMA could cost 5 cents per minute but the voice quality would be high. The user could then select which service to use based on the user's needs.

If costs for voice and data services are different at different times of the day, this can also be provided to the user.

The above is not meant to be limiting to the type of cost indicators that could be provided and other indicators would be evident to those skilled in the art having regard to the present disclosure. The items on display 120 of FIG. 1 are not meant to be limiting. Further, the items shown on display 120 of FIG. 1 could be used alone and without any of the other items shown or could be used in combination with one or more of the other items on display 120.

In a further embodiment, a speaker 140 could be used to provide audio indications of the call costs rather than or in conjunction with the use of a display 120.

Further, where information is not available to provide an accurate or estimated cost, the indicator could provide a warning to the user that no information is available regarding the cost or that the cost is unknown.

In one embodiment, once the cost information is collected and available, the user or enterprise IT policy can use the cost information to set thresholds for acceptable costs for a mobile service. Thus, for example, a policy may be to allow only large downloads, such as music files, to occur when the device is connected over WiFi or a ceiling could be set for the highest cost that a user is willing to pay for bandwidth to download a podcast, for example. Thus, the user or enterprise may set a rule to only allow downloads of the selecting music files or podcasts when the cost for the data transfer is lower than 0.01 cents per megabyte.

Further, voice calls can be limited to certain maximum costs or restricted to certain times of the day. These decisions are based on the cost of these activities, which are in turn a function of the network service in use and the associated subscription and billing plan.

In one embodiment, the thresholds can be used to provide warnings. Thus, for example, if the user's actions fall below the threshold, the action can proceed without verification. However, if the user's actions result in a cost being above a threshold, then the user may need to confirm that he or she wishes to proceed with his or her actions. A user downloading a large file with a cost estimate of 0.02 cents per megabyte may need to verify that the user indeed wishes to proceed where the threshold is set at 0.01 cents per megabyte for file downloads. Other examples would be evident to those skilled in the art.

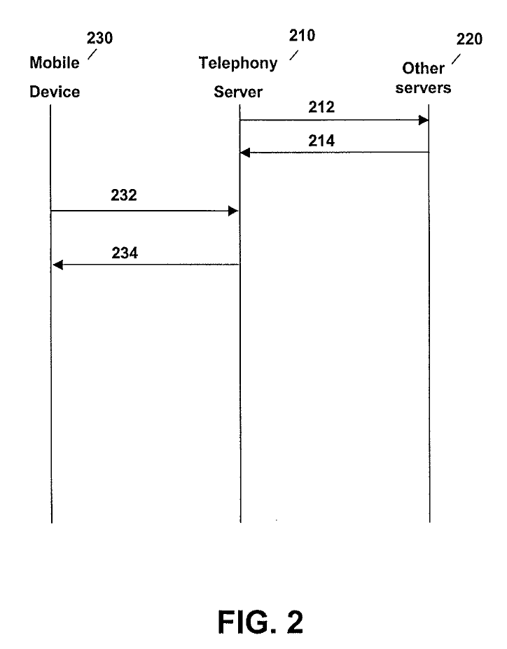

Reference is now made to FIG. 2. FIG. 2 illustrates a data flow diagram of one embodiment for implementing the above captioned indicators.

In the embodiment of FIG. 2, a telephony server 210 can be used to collect information about a user's billing plan and information regarding the user's telephone service usage. The telephony server 210 communicates with other servers 220 to collect this information, for example in messages 212 and 214.

The retrieved information is stored on telephony server 210.

In the embodiment of FIG. 2, mobile device 230 communicates with telephony server 210 to obtain information stored on telephony server 210.

In one embodiment, mobile device 230 can send a specific query regarding the cost of a specific action. Thus, for example, if a user is making a telephone call, prior to the user making the call, a query 232 can be sent between mobile device 230 and telephony server 210. Query 232 includes the telephone number that mobile device 230 is planning to call. As will be appreciated, query 232 will preferably include information identifying mobile device 230 to telephony server 210.

In response to query 232, telephony server 210 sends a response 234 indicating the cost of the action specified in query 232. In this way, mobile device 230 can inform a user about the costs of a planned action and allows a user to make a more informed decision about whether the user wishes to proceed with the planned action.

Query 232 can be used to obtain a variety of cost information. For example, the query 232 could relate to the costs for downloading a file. Specifically, if a user clicks on a URL to download a specific page, then query 232 could include the URL to telephony server 210. The query 232 could include the size of the page or telephony server 210 could obtain the size of the page and based on this information and the billing plans, data charges, roaming charges or any other information about mobile device 230, telephony server 210 could provide a response 234 indicating the cost of downloading the file.

Query 232 could also be used to obtain non-cost information. For multi-mode devices it may be desirable for a user to have quality of service information for the communications channels the device is able to use, and thus query 232 could be used to obtain quality of service information, instead of or in addition to cost information.

Other alternatives would be apparent to those skilled in the art.

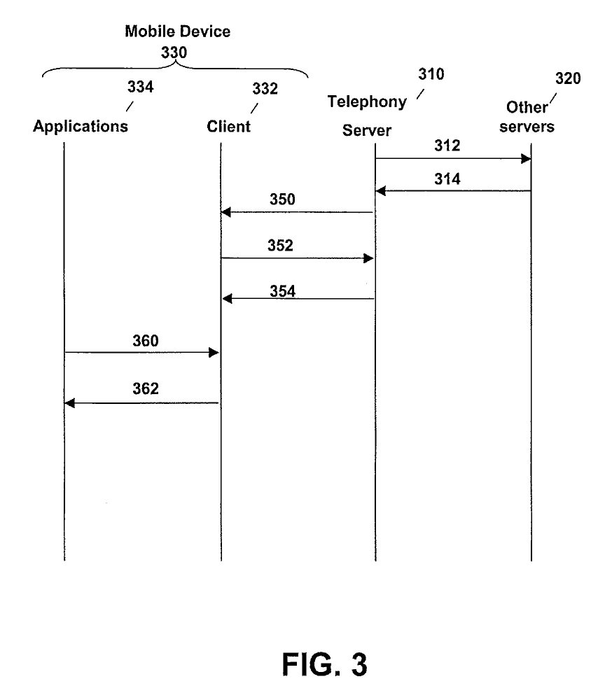

Reference is now made to FIG. 3. In a further embodiment, mobile device 330 could include a cost client 332 communicating with mobile applications 334.

Cost client 332 communicates with telephone server 310 to collect and store information about the costs for services. Specifically, telephony server 310 communicates with other servers 320 to obtain information in messages 312 and 314. Other servers 320 could include carrier billing information, accounting, home location register/visited location register (HLR/VLR) or other network service providers.

Telephony server 310 stores this information and can either periodically send this information in message 350 to client 332. Alternatively, client 332 could provide a query 352 to telephony server 310 asking for information and telephony server 310 could provide a response 354 providing the information to client 332.

As will be appreciated by those skilled in the art, client 332 could send a request 352 when, for example, the mobile device 330 changes networks, is turned on, or for other reasons that would be appreciated by those skilled in the art.

When an application 334 for a mobile service is launched or an action started, or if a user launches a query about the cost of a mobile service, application 334 can send a query 360 to client 332 and client 332 can respond with a message 362 to application 334. Such information is stored by client 332 based on communications with telephony server 310.

The application 334 can then display the information or provide the information in another way to the user. Further, application 334 can use the information to compare with a threshold to ensure that the cost for the mobile service does not exceed a predetermined value. If the cost does exceed the predetermined value, the user can be prompted to verify that he or she wishes to proceed, or the transaction can be blocked, for example.

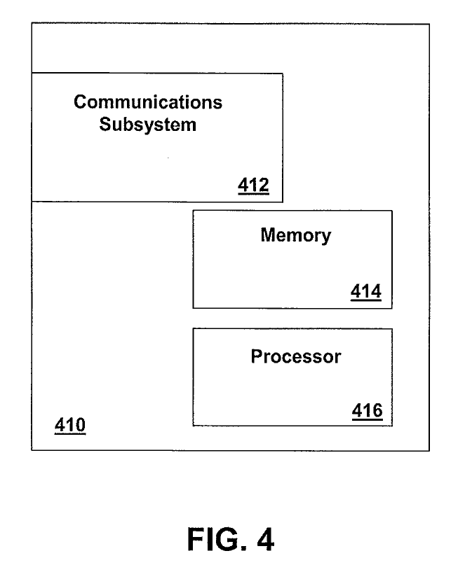

Reference is now made to FIG. 4. FIG. 4 illustrates a simplified block diagram of a telephony server. Telephony server 410 includes a communications subsystem 412 adapted to both communicate with other servers such as other servers 220 from FIG. 2 or other servers 320 from FIG. 3. Communications subsystem 412 is further adapted to communicate with a mobile device such as a mobile device 110 from FIG. 1, 230 from FIGS. 2 and 330 from FIG. 3.

Telephony server 410 further includes memory 414 and a processor 416.

Processor 416 is adapted to get cost information from other servers, such as other servers 220 from FIG. 2 and 320 from FIG. 3. Memory 414 is adapted to store this information.

Processor 416 is further adapted to receive and process queries from a mobile device, such as mobile device 110, 230 or 330 from FIG. 1, 2 or 3 respectively, and to provide a response using communication subsystem 412 to these mobile devices.

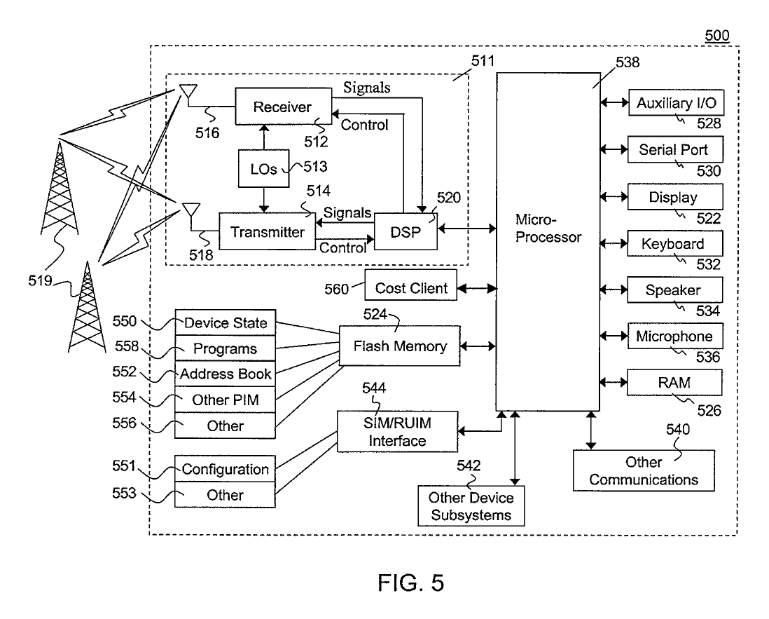

As will be appreciated by those skilled in the art, various mobile devices could be used to provide the user with an indication of the cost for a mobile service in order to allow the user to make a better decision regarding whether or not to complete a mobile service. One exemplary mobile device is illustrated with regard to FIG. 5.

FIG. 5 is a block diagram illustrating a mobile device apt to be used with preferred embodiments of the apparatus and method of the present application. Mobile device 500 is preferably a two-way wireless communication device having at least voice and data communication capabilities. Mobile device 500 preferably has the capability to communicate with other computer systems on the Internet. Depending on the exact functionality provided, the wireless device may be referred to as a data messaging device, a two-way pager, a wireless e-mail device, a cellular telephone with data messaging capabilities, a wireless Internet appliance, or a data communication device, as examples.

Where mobile device 500 is enabled for two-way communication, it will incorporate a communication subsystem 511, including both a receiver 512 and a transmitter 514, as well as associated components such as one or more, preferably embedded or internal, antenna elements 516 and 518, local oscillators (LOs) 513, and a processing module such as a digital signal processor (DSP) 520. As will be apparent to those skilled in the field of communications, the particular design of the communication subsystem 511 will be dependent upon the communication network in which the device is intended to operate.

Network access requirements will also vary depending upon the type of network 519. In some CDMA networks, for example, network access is associated with a subscriber or user of mobile device 500. A CDMA mobile device may require a removable user identity module (RUIM) or a subscriber identity module (SIM) card in order to operate on a CDMA network. The SIM/RUIM interface 544 is normally similar to a card-slot into which a SIM/RUIM card can be inserted and ejected like a diskette or PCMCIA card. The SIM/RUIM card can have approximately 64K of memory and hold many key configuration 551, and other information 553 such as identification, and subscriber related information.

When required network registration or activation procedures have been completed, mobile device 500 may send and receive communication signals over the network 519. As illustrated in FIG. 5, network 519 can consist of multiple base stations communicating with the mobile device. For example, in a hybrid CDMA 1x EVDO system, a CDMA base station and an EVDO base station communicate with the mobile device and the mobile device is connected to both simultaneously. The EVDO and CDMA 1x base stations use different paging slots to communicate with the mobile device.

Signals received by antenna 516 through communication network 519 are input to receiver 512, which may perform such common receiver functions as signal amplification, frequency down conversion, filtering, channel selection and the like, and in the example system shown in FIG. 5, analog-to-digital (A/D) conversion. A/D conversion of a received signal allows more complex communication functions such as demodulation and decoding to be performed in the DSP 520. In a similar manner, signals to be transmitted are processed, including modulation and encoding for example, by DSP 520 and input to transmitter 514 for digital-to analog-conversion, frequency-up-conversion, filtering, amplification and transmission over the communication network 519 via antenna 518. DSP 520 not only processes communication signals, but also provides for receiver and transmitter control. For example, the gains applied to communication signals in receiver 512 and transmitter 514 may be adaptively controlled through automatic gain control algorithms implemented in DSP 520.

Mobile device 500 preferably includes a microprocessor 538, which controls the overall operation of the device. Communication functions, including at least data and voice communications, are performed through communication subsystem 511. Microprocessor 538 also interacts with further device subsystems such as the display 522, flash memory 524, random access memory (RAM) 526, auxiliary input/output (I/O) subsystems 528, serial port 530, one or more keyboards or keypads 532, speaker 534, microphone 536, other communication subsystem 540 such as a short-range communications subsystem and any other device subsystems generally designated as 542. Serial port 530 could include a USB port or other port known to those in the art.

Some of the subsystems shown in FIG. 5 perform communication-related functions, whereas other subsystems may provide “resident” or on-device functions. Notably, some subsystems, such as keyboard 532 and display 522, for example, may be used for both communication-related functions, such as entering a text message for transmission over a communication network, and device-resident functions such as a calculator or task list.

Operating system software used by the microprocessor 538 is preferably stored in a persistent store such as flash memory 524, which may instead be a read-only memory (ROM) or similar storage element (not shown). Those skilled in the art will appreciate that the operating system, specific device applications, or parts thereof, may be temporarily loaded into a volatile memory such as RAM 526. Received communication signals may also be stored in RAM 526.

As shown, flash memory 524 can be segregated into different areas for both computer programs 558 and program data storage 550, 552, 554 and 556. These different storage types indicate that each program can allocate a portion of flash memory 524 for their own data storage requirements. Various collections are also stored in flash memory 524. Microprocessor 538, in addition to its operating system functions, preferably enables execution of software applications on the mobile device. A predetermined set of applications that control basic operations, including at least data and voice communication applications for example, will normally be installed on mobile device 500 during manufacturing. Other applications could be installed subsequently or dynamically.

A preferred software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application would preferably have the ability to send and receive data items, via the wireless network 519. In a preferred embodiment, the PIM data items are seamlessly integrated, synchronized and updated, via the wireless network 519, with the mobile device user's corresponding data items stored or associated with a host computer system. Further applications may also be loaded onto the mobile device 500 through the network 519, an auxiliary I/O subsystem 528, serial port 530, short-range communications subsystem 540 or any other suitable subsystem 542, and installed by a user in the RAM 526 or preferably a non-volatile store (not shown) for execution by the microprocessor 538. Such flexibility in application installation increases the functionality of the device and may provide enhanced on-device functions, communication-related functions, or both. For example, secure communication applications may enable electronic commerce functions and other such financial transactions to be performed using the mobile device 500.

In a data communication mode, a received signal such as a text message or web page download will be processed by the communication subsystem 511 and input to the microprocessor 538, which preferably further processes the received signal for output to the display 522, or alternatively to an auxiliary I/O device 528.

A user of mobile device 500 may also compose data items such as email messages for example, using the keyboard 532, which is preferably a complete alphanumeric keyboard or telephone-type keypad, in conjunction with the display 522 and possibly an auxiliary I/O device 528. Such composed items may then be transmitted over a communication network through the communication subsystem 511.

For voice communications, overall operation of mobile device 500 is similar, except that received signals would preferably be output to a speaker 534 and signals for transmission would be generated by a microphone 536. Alternative voice or audio I/O subsystems, such as a voice message recording subsystem, may also be implemented on mobile device 500. Although voice or audio signal output is preferably accomplished primarily through the speaker 534, display 522 may also be used to provide an indication of the identity of a calling party, the duration of a voice call, or other voice call-related information for example.

Serial port 530 in FIG. 5 would normally be implemented in a personal digital assistant (PDA)-type mobile device for which synchronization with a user's desktop computer (not shown) may be desirable, but is an optional device component. Such a port 530 would enable a user to set preferences through an external device or software application and would extend the capabilities of mobile device 500 by providing for information or software downloads to mobile device 500 other than through a wireless communication network. The alternate download path may for example be used to load an encryption key onto the device through a direct and thus reliable and trusted connection to thereby enable secure device communication. As will be appreciated by those skilled in the art, serial port 530 can further be used to connect the mobile device to a computer to act as a modem.

Other communications subsystems 540, such as a short-range communications subsystem, is a further optional component which may provide for communication between mobile device 500 and different systems or devices, which need not necessarily be similar devices. For example, the subsystem 540 may include an infrared device and associated circuits and components or a Bluetooth™ communication module to provide for communication with similarly enabled systems and devices.

A cost client 560 could be used to track the cost of mobile services.

The embodiments described herein are examples of structures, systems or methods having elements corresponding to elements of the techniques of this disclosure. This disclosure may enable those skilled in the art to make and use embodiments having alternative elements that likewise correspond to the elements or the techniques of this disclosure. The intended scope of the techniques of this disclosure thus includes other structures, systems or methods that do not defer from the techniques of the disclosure as described herein, and further includes other structures, systems or methods within substantial differences from the techniques of this disclosure as described herein.

1. A method to enhance decision making capabilities of a user of a mobile device comprising the steps of:
receiving, at the mobile device, information related to the cost of mobile services; and
communicating an indication of the cost of mobile services to the user.

2. The method of claim 1, wherein the information related to the cost of mobile services is selected from the group consisting of: cost per minute for a voice call to a long distance destination; cost per minute for local calls; applied roaming charges; number of minutes consumed and available in a user's calling plan over a specified time period; number of bytes transmitted and received over a period; current consumption of data transfers and bytes remaining before additional charges are incurred; and time dependent telephone or data transfer costs.

3. The method of claim 1, wherein the information related to the cost of mobile services is received from a telephony server adapted to compile the information related to the cost of mobile services.

4. The method of claim 3, further comprising the step of querying the telephony server, prior to completing a mobile service, for the cost of the mobile service,
whereby said information related to the cost of mobile services relates to the mobile service being completed.

5. The method of claim 3, further comprising the step of storing, at the mobile device, the information related to the cost of mobile services,
whereby the communication of the indication of the cost of mobile services is based on information stored on the mobile device.

6. The method of claim 5, wherein the information is received periodically.

7. The method of claim 6, wherein the information is received whenever the mobile device enters a new network.

8. The method of claim 1, wherein the communicating step provides an audio indication.

9. The method of claim 1, wherein the communicating step provides a visual indication.

10. The method of claim 9, wherein the visual indication is one or more of:
a passive icon a user can select to show current costs of calls to various destinations, allow a user to input a telephone number and find the cost of making a call to the telephone number, or find the cost of an ongoing voice call or data transfer;
a window displayed to a user after a user selects a mobile service, indicating the cost of the mobile service;
a window showing a running total of the cost of a mobile service and a final cost once the mobile service has ended;
a visual element indicating number of minutes used and remaining in a billing plan; and
a visual element indicating number of bytes downloaded and number of bytes remaining before extra billing is incurred in a billing plan;

11. The method of claim 1, wherein said mobile device is a multi-mode device, said communicating step providing a comparison of costs for the mobile service over two or more communications channels.

12. The method of claim 11, wherein the receiving step further receives information related to the quality of service for each of the two or more communications channels and said communicating step provides, with the comparison of costs, the information related to the quality of service for each of the two or more communications channels.

13. The method of claim 1, further comprising the step of:
setting a threshold for a maximum cost of a mobile service; and
limiting the mobile service if the cost of the mobile service is greater than the threshold.

14. The method of claim 13, wherein the limiting step includes prompting a user for confirmation that the user wishes to proceed.

15. The method of claim 14, wherein the limiting step includes prohibiting the mobile service.

16. A mobile device adapted to enhance decision making capabilities of a user comprising:
a receiver adapted to receive information related to the cost of mobile services; and
an output adapted to provide an indication of the cost of mobile services to the user.

17. The mobile device of claim 16, wherein the information related to the cost of mobile services is selected from the group consisting of: cost per minute for a voice call to a long distance destination; cost per minute for local calls; applied roaming charges; number of minutes consumed and available in a user's calling plan over a specified time period; number of bytes transmitted and received over a period; current consumption of data transfers and bytes remaining before additional charges are incurred; and time dependent telephone or data transfer costs.

18. The mobile device of claim 16, wherein the information related to the cost of mobile services is received from a telephony server adapted to compile the information related to the cost of mobile services.

19. The mobile device of claim 18, further comprising a transmitter adapted to querying the telephony server, prior to completing a mobile service, for the cost of the mobile service, wherein said information related to the cost of mobile services relates to the mobile service being completed.

20. The mobile device of claim 18, further comprising memory adapted to store the information related to the cost of mobile services, wherein the output is adapted to communicate the cost of mobile services based on information stored in the memory.

21. The mobile device of claim 16, wherein the output is speaker adapted to provide an audio indication.

22. The mobile device of claims 16, wherein the output is a display adapted to provide a visual indication.

23. The mobile device of claim 22, wherein the visual indication is one or more of:
a passive icon a user can select to show current costs of calls to various destinations, allow a user to input a telephone number and find the cost of making a call to the telephone number, or find the cost of an ongoing voice call or data transfer;
a window displayed to a user after a user selects a mobile service, indicating the cost of the mobile service;
a window showing a running total of the cost of a mobile service and a final cost once the mobile service has ended;
a visual element indicating number of minutes used and remaining in a billing plan; and
a visual element indicating number of bytes downloaded and number of bytes remaining before extra billing is incurred in a billing plan;

24. The mobile device of claim 16, wherein said mobile device is a multi-mode device having two or more communications channels, said output adapted to provide a comparison of costs for the mobile service over the two or more communications channels.

25. The mobile device of claim 24, wherein the receiver is further adapted to receive information related to the quality of service for each of the two or more communications channels and the output is adapted to provide, with the comparison of costs, the information related to the quality of service for each of the two or more communications channels.

26. The mobile device of claim 16, further comprising a processor adapted to compare the cost of a mobile service with a threshold and limit the mobile service if the cost of the mobile service is greater than the threshold.

27. The mobile device of claim 26, wherein the mobile device is adapted to prompt a user for confirmation that the user wishes to proceed if the cost of the mobile service is greater than the threshold.

28. A telephony server comprising:
a communications subsystem;
a processor adapted to query, through said communications subsystem, other servers regarding costs of mobile services; and
memory for storing results of the queries by the processor related to information for the costs of mobile services,
wherein said communications subsystem is further adapted to communicate the information for the costs of mobile services to one or more mobile devices.

29. The telephony server of claim 28, wherein the information related to the cost of mobile services is selected from the group consisting of: cost per minute for a voice call to a long distance destination; cost per minute for local calls; applied roaming charges; number of minutes consumed and available in a user's calling plan over a specified time period; number of bytes transmitted and received over a period; current consumption of data transfers and bytes remaining before additional charges are incurred; and time dependent telephone or data transfer costs.

30. The telephony server of claim 28, wherein the information related to the cost of mobile services is communicated to the one or mobile devices in response to a query by the one or more mobile devices.

31. The telephony server of claim 28, wherein the telephony server is adapted to communicate the information for the costs of the mobile services to each of the one or more mobile devices when the each of said one or more mobile devices changes networks.
